(19) United States
(12) Patent Application Publication
(10) Pub. No.: US 2003/0162508 A1
(43) Pub. Date: Aug. 28, 2003

(54) Miniature electronic personal locator beacon

(76) Inventor: Moises Macias, Southampton (GB)

Correspondence Address: Gregory J Lavorgna, Drinker Biddle & Reath, One Logan Square, 18th & Cherry Street, Philadelphia, PA, 19103-6996, US

(21) Appl. No.: 10/258,417

(22) PCT Filed: Apr. 30, 2001
(86) PCT No.: PCT/GB01/01894

(30) Foreign Application Priority Data
Apr. 29, 2000 (GB) 0010382.0

(51) Int. Cl. H04B 1/38

(52) U.S. Cl. 455/90; 455/550; 455/456

(57) ABSTRACT

An electronic personal locator (EPL) having a first inner housing containing a radio frequency signal generator connected to an antenna. The inner housing is located inside a second outer housing which contains activation means for activating the signal generator and a power source, both of which are operatively connected to the radio frequency generator. The antenna has a fixed shape which allows it to transmit a constant radio frequency output for a given input power and the EPL is of a compact design such that it can be conveniently worn by a person.

The present invention relates to personal locator devices, including Emergency Position Indicating Radio Beacons (EPIRBs), Electronic Personal Locators (EPLs) and the like.

EPL devices are commonly used as a means of locating a person who is, for example, lost overboard from a ship or on a mountainside.

Standard EPL devices transmit a signal on an international search and rescue (SAR) frequency of 121.5 MHz which is an international standard for homing direction finding.

As vessels and/or rescue services are aware of this standard, they have receivers tuned to this frequency and any signal detected at this frequency is recognised as being from a lost person.

There are a number of commercially available EPLs. These devices are relatively large, having typical dimensions greater than 6 cm×25 cm×7 cm and can be worn around the neck of the person like a medallion.

In one example, a loop of approximately 60 cm in length is attached to the EPL and is used to hang the EPL around the person's neck. The loop is typically made of neoprene rubber and contains the antenna which is fitted coaxially within the rubber loop, approximately at its centre. Whilst the rubber loop provides a tough, flexible casing for the antenna, its inherent flexibility allows the physical shape of the antenna to be changed simply by movement of the loop. In particular, if the loop becomes twisted, the efficiency of transmission of the antenna can be affected. Twisting and other bending of the loop can greatly attenuate the range over which the signal is transmitted, typically by a factor of 10. In extreme cases, it has been shown that the transmission range of the antenna can be reduced to a few metres.

Another type of personal locator has approximate dimensions of 20 cm×5 cm×4 cm and has a semi-rigid antenna which protrudes from the top of the device.

These types of EPL are inconvenient to carry and wear, especially when the person is wearing light summer clothing or swimwear and are uncomfortable when worn in bed, as is often required aboard sea-going vessels.

In accordance with the present invention there is provided 1 an electronic personal locator comprising a radio frequency signal generation connected to an antenna and activation means for activating said signal generation; and in which the antenna is of a fixed shape and is contained together with the signal generator within a housing, which housing is of a configuration which can be conveniently worn by a person.

Preferably, the radio frequency signal generation means is mounted on a first printed circuit board and said antenna contained on a second printed circuit board, said first and second printed circuit boards being connected by a spacer.

Optionally, the antenna is a wire loop contained within the housing.

Preferably, the means for generating a radio frequency signal comprises a control circuit, connected to a radio frequency generator and to an amplifier.

Preferably, the control circuit is a microprocessor.

Preferably, the antenna is etched into the surface of said second printed circuit board.

Preferably, the housing is sealed to prevent the ingress of fluids.

Preferably, the activation means is operable manually by operation of a switch situated outside the housing.

Preferably, the activation means is operable automatically on immersion in water on actuation of a water sensor.

Preferably, the water sensor comprises a pair of conducting elements located on the outer surface of the outer housing and forming an open circuit, said elements being connected to said signal generation means, such that, on immersion in water, the open circuit is completed which causes said signal generation means to be actuated.

Preferably, the apparatus of the present invention further comprises light emitting means connected to the radio frequency signal generation means.

Preferably, the apparatus of the present invention further comprises audio emission means connected to the radio frequency signal generation means.

Preferably, the audio signal generation means and said visual signal generation means have a common interface with the radio frequency signal generation means.

Preferably, the housing comprises an inner housing containing the signal generator and the antenna, and an outer housing surrounding the inner housing and containing a power source interface; and wherein said outer housing contains a display screen the housing comprises an inner housing contained.

Preferably, the display screen functions as a watch.

Preferably, the the watch is controlled by a watch circuit contained in a third housing located inside the outer housing.

Preferably, the watch is operated by the control circuit.

Preferably, the housing is provided with a strap and the housing and strap are dimensioned to be worn on the wrist or ankle of a person.

Embodiments of the present invention will now be described, by way of example only, with reference to the accompanying drawings in which:

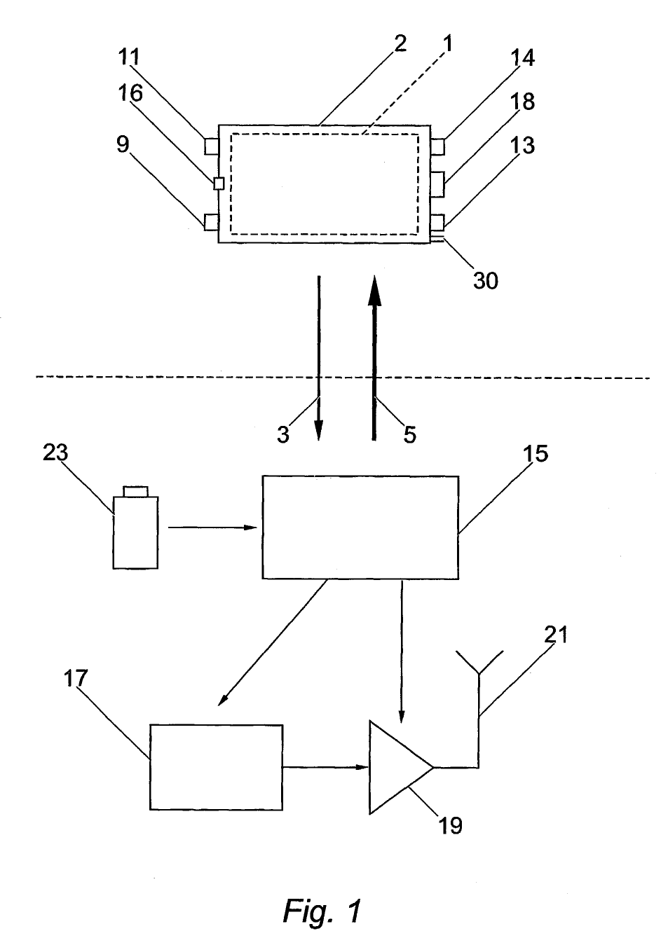

FIG. 1 shows a schematic block diagram of an embodiment of an Electronic Personal Locator (EPL) in accordance with the present invention;

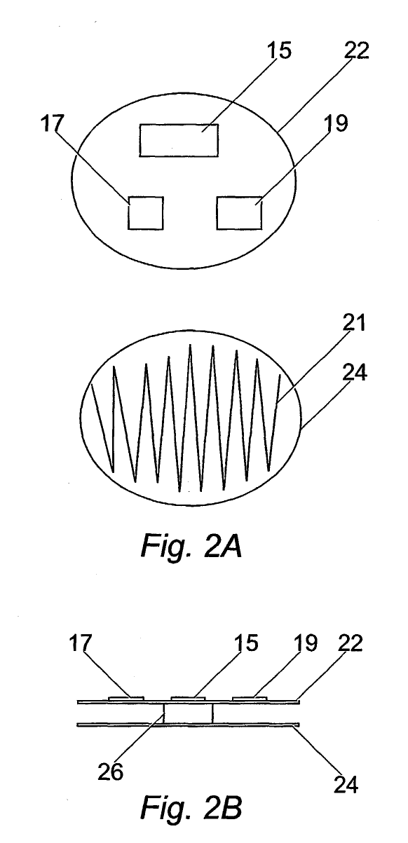

FIG. 2a shows a printed circuit board (PCB) containing the electronic components of the EPL and a PCB having an antenna etched onto its surface and FIG. 2b shows these PCBs attached together via a spacer;

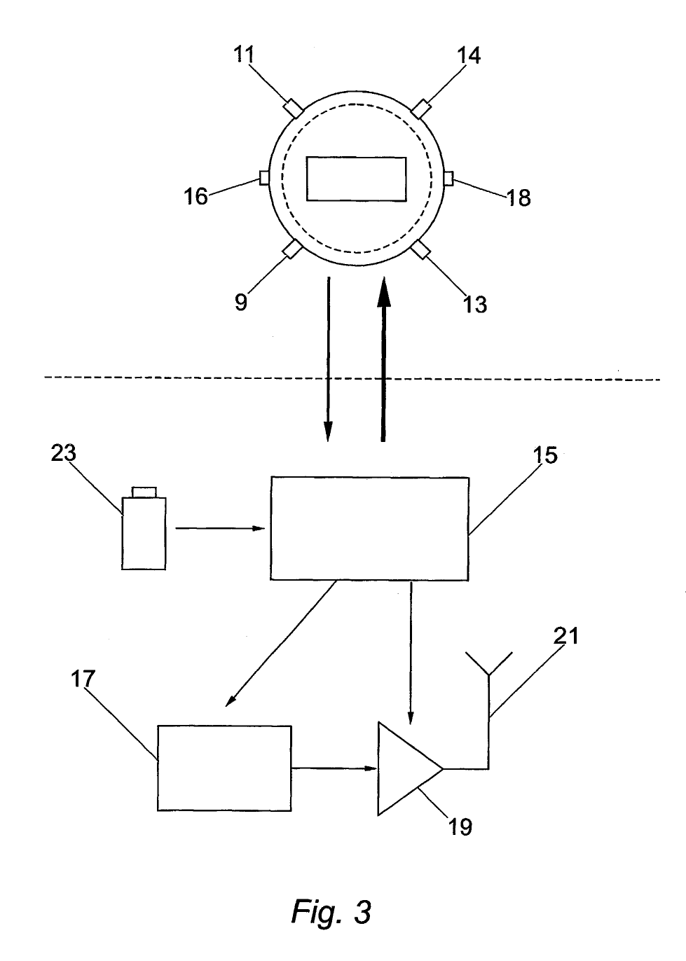

FIG. 3 shows a schematic diagram of an embodiment of an EPL in accordance with the invention fitted within a wristwatch;

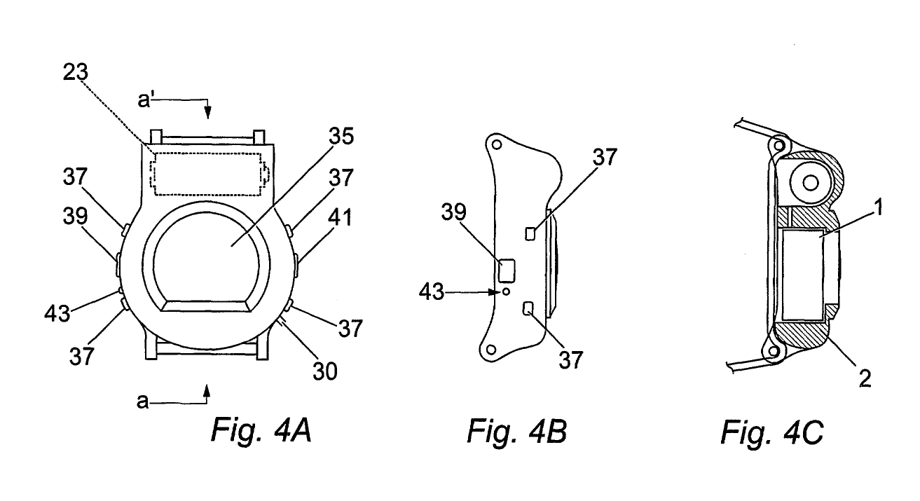

FIGS. 4a, 4b, 4c are a plan view, a side view and a cross sectional side view of a wristwatch in accordance with the embodiment of the present invention of FIG. 3 and FIG. 4d shows this embodiment of the present invention with a strap for attaching it to a person's wrist;

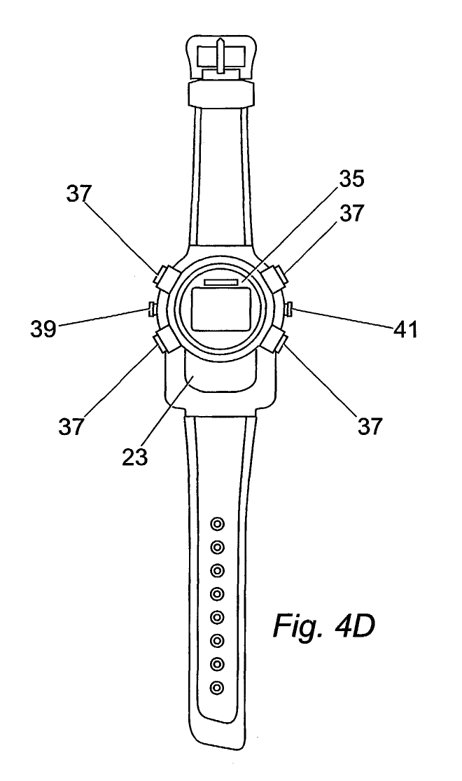

FIGS. 5a, 5b and 5c are a plan view, a side view and a cross sectional side view of a wristwatch in accordance with an alternative embodiment of the present invention;

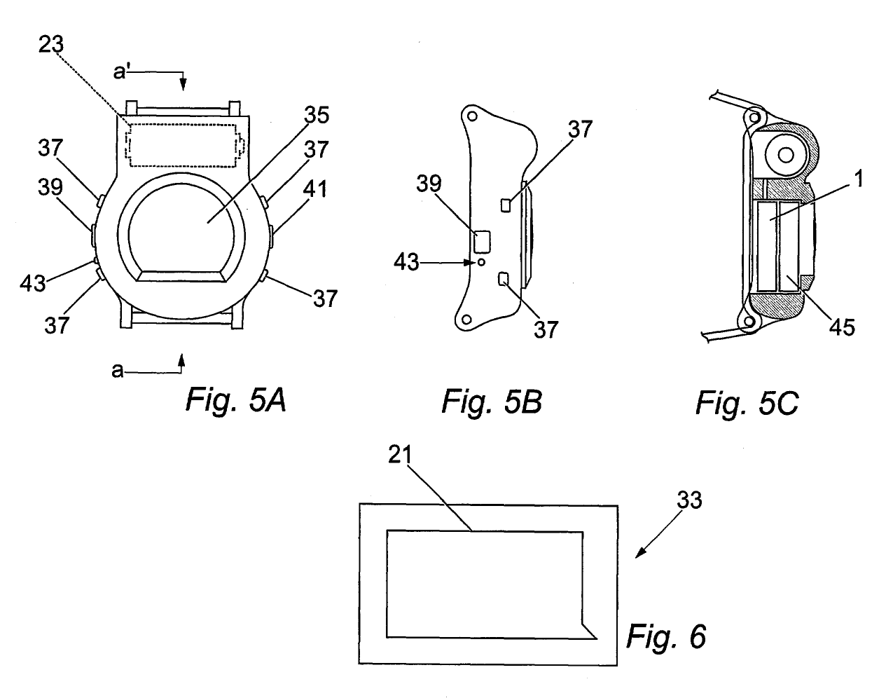

FIG. 6 is a diagram illustrating an antenna attached to a housing.

FIG. 1a shows a schematic diagram of an EPL in accordance with the present invention. The top half of this figure shows the outer surface of the EPL and the bottom half shows the functional relationship between the components contained inside the inner housing. In addition arrows 3 and 5 show the functional relationship between the switches and indicator and the internal components of the EPL.

The transmitter comprises an inner housing 1 which contains a microcontroller 15, signal generator 17, amplifier 19 and antenna 21. A power source (battery) 23 is located outside in the outer housing 2. Arrow 3 indicates a control signal path from any one of the buttons located on the external surface of the inner housing 1 to the microcontroller 15. In this embodiment of the present invention a number of switches and sensors are located on the outer surface of the outer housing. Switch 9 is used to turn on, or arm the transmitter, switch 11 is used to provide a low power test signal detectable over a short distance, switch 13 is used to switch the device from manual to automatic operation and switch 18 is used to confirm that the device has been switched on. Visual and audio confirmation of the status of the device are provided by light emitting diode 14 and audio output 18. These indicators provide information on the power level in the battery and an indication of whether the EPL has been switched on.

The inner housing is constructed from fibreglass into a robust gas and watertight compartment for the electronic components, is virtually transparent to RF signals and therefore does not attenuate transmission of the RF signal from the antenna.

The microcontroller 15 is connected to the radio frequency (RF) generator and modulator 17 the RF power amplifier (PA) 19 and the antenna 21. The microcontroller 15 is also connected to the battery 23. The microcontroller 15 provides power and signals to the RF generator and modulator 17 to switch on or off the RF generator and to modulate the signal.

In this example, the microcontroller is an 8-bit, fully static, EPROM/ROM-based CMOS microcontroller. The microcontroller has a sleep mode which allows it to be dormant during periods of non-use in order to save power. The microcontroller 15 output is a square wave the shape of which is controlled by running programmed sequences on the microcontroller 15. The square wave signal is then mixed by a voltage controlled oscillator and resonator in the RF modulator 17 to achieve a unique EMF which is then amplified by the power amplifier 19. The microcontroller 15 is also directly connected to the RF power amplifier 19.

The microcontroller 15, RF generator and modulator 17 and the RF power amplifier 19 are mounted on a printed circuit board 22 (PCB) as shown schematically in FIG. 2a. The antenna 21 is a strip antenna etched into the surface of a second PCB 24. In this example, the antenna 21 is etched in a zigzag pattern across the surface of PCB 24 in order to provide a sufficient length and correct shape of antenna for the wavelength and power output required. A connection 28 is provided between power amplifier 19 and antenna 21. In this example, the PCBs 22 and 24 are substantially circular, of the same dimensions and are arranged to be mounted adjacent to and coplanar with one other, being separated by a spacer 26 as seen in FIG. 2b.

Alternatively, the antenna 21 can be connected to the RF power amplifier and located on the inside surface of the inner housing 1. In such cases, the antenna is in the form of a loop which is fixed to the surface of the protective casing in such a way so as to prevent movement of the wires of the antenna loop.

In both of the above cases, the antenna has a fixed shape and produces a constant RF output for a given power input.

The device may be operated in manual or automatic mode. In manual mode when, for example, a person falls overboard from a boat, they activate the device by pressing the switch 9. This sends a control signal 3 to the microcontroller 15, power is drawn from the power cell 23, the microcontroller 15 sends a signal to the RF generator and modulator 17 which generates an RF electrical signal as described above. The RF signal is then sent to the RF power amplifier 19 for amplification and then to the antenna 21 and is then transmitted as radio waves.

As previously stated, EPLs of this type will usually be set to transmit at a frequency of 121.5 MHz, the internationally recognised frequency for transmitting search and rescue (SAR) signals. However, the present invention is not restricted to operation at this frequency.

Alternatively or additionally, the device may be pre-set to be activated automatically on immersion in water. The immersion sensor consists of two stainless steel pins 30 located on the outside surface of the EPL which are each connected to the PLB circuit via contact clips that are soldered into the PLB board. One of the pins is connected to the power source and the other to an internal RC network and a Schmitt inverter. When submerged in water, the water will act as a 2K ohm to 100K ohm resistor, (depending on the water type) across the two pins, thereby allowing current to flow in the RC network thereby charging the capacitor. Once the capacitor has been charged to a certain level, the Schmitt inverter will change its output level signal and actuate the microcontroller. Thus, the alarm will activate only after it is immersed for a given time, typically about 4 s. In addition, the automatic activation sensor may be set so that it does not activate the device when the sensor becomes wet from spray or rainwater or tap water.

FIG. 3 and FIGS. 4a, 4b and 4c show an EPL in accordance with the present invention in which the EPL is fitted into the casing of a wristwatch.

FIG. 3 shows a schematic diagram similar to that given in FIG. 1a. The microcontroller 15 and other circuitry are identical to those in FIG. 1a and have been given the same reference numerals. The inner housing 1 is shown in FIGS. 4a, 4b and 4c. The circuitry comprising the microcontroller 15, RF generator and modulator 17, and the RF power amp 19 are contained therein as is shown in FIG. 3. The power cell 23 is situated outside the inner housing 1 but inside the watch casing 48. In addition, the watch function of the device is run through the clock on microcontroller 15. Therefore, this embodiment of the present invention does not require a separate clock mechanism to operate the watch and is therefore slimmer than alternative embodiments which contain a separate clock mechanism along with the inner housing 1.

Referring to FIGS. 4a, 4b and 4c, there is shown a watch face 35. On the peripheral edges of the watch there are provided a number of buttons for controlling both wristwatch and EPL functions. Buttons 37 are used for changing the mode of operation of the watch. Buttons 39 and 41 are connected to the microcontroller 15. Button 39 provides an on/off switch for activating or deactivating the EPL. Button 41 provides a means for switching from a manual to automatic EPL mode. In addition, there is provided a clear panel 43 with a light emitting diode (LED) behind it. The LED is connected to the microcrontroller and emits light when the RF signal is being transmitted. In addition, an audio output 40 in the form of a piezoelectric device is also contained on the inner housing to provide an audio output when the RF signal is being emitted. Water sensor 30 as previously described is also attached to the surface of the watch as shown.

FIG. 4d shows this embodiment of the present invention fitted to a strap to be worn around the wrist or ankle.

FIGS. 5a to 5c show an alternative embodiment of the present invention containing a separate watch mechanism 45 and inner housing 1 located inside the watch casing behind the watch face 35. In this embodiment, antenna 21 is situated on the inner surface of the inner housing 1. FIG. 6 is a plan view of the inner housing 1 which shows the antenna 21 fixed to its inner surface.

As a result of its size, the present invention can be easily and comfortably worn by a person at all times whilst e.g. on board a boat. When the device is activated, the fixed shape of the antenna ensures that the range of the signal is constant and is only affected by the power available from the power supply. When in use at full power, the signal at 121.5 MHz can be detected at a range of 15 miles from airborne craft and at 1.5 miles from sea or landborne craft. The device can also be detected by satellite. It will be appreciated that the range of the EPL on land is also affected by the presence of obstacles such as hills.

Embodiments of the present invention have been certified as safe for use in potentially explosive atmospheres such as found on oil rigs. The apparatus may be produced in intrinsically safe form; alternatively, the housing may be sealed for electrical safety.

In other embodiments of the invention, the apparatus may receive as well as transmit information. In particular, the display screen may be used to display information such as ship's heading and speed, and wind direction and speed, received by low power digital transmission from a ship instrument system.

The apparatus may also be used for non-emergency purposes, for example to track the location of individuals within a building or a ship.

Improvements and modifications may be incorporated herein without departing from the scope of the invention.

1. An electronic personal locator comprising a radio frequency signal generation connected to an antenna and activation means for activating said signal generation; and in which the antenna is of a fixed shape and is contained together with the signal generator within a housing, which housing is of a configuration which can be conveniently worn by a person.

2. Apparatus as claimed in claim 1 wherein said radio frequency signal generation means is mounted on a first printed circuit board and said antenna contained on a second printed circuit board, said first and second printed circuit boards, being connected by a spacer.

3. Apparatus as claimed in claim 1, in which the antenna is a wire loop contained within the housing.

4. Apparatus as claimed in any preceding claim wherein said means for generating a radio frequency signal comprises a control circuit, connected to a radio frequency generator and to an amplifier.

5. Apparatus as claimed in any preceding claim wherein said control circuit is a microprocessor.

6. Apparatus as claimed in claim 2 wherein said antenna is etched into the surface of said second printed circuit board.

7. Apparatus as claimed in any preceding claim wherein said housing is sealed to prevent the ingress of fluids.

8. Apparatus as claimed in any preceding claim wherein said activation means is operable manually by operation of a switch situated outside the housing.

9. Apparatus as claimed in any of claims 1 to 7 wherein said activation means is operable automatically on immersion in water on actuation of a water sensor.

10. Apparatus as claimed in claim 9 wherein the water sensor comprises a pair of conducting elements located on the outer surface of the outer housing and forming an open circuit, said elements being connected to said signal generation means, such that, on immersion in water, the open circuit is completed which causes said signal generation means to be actuated.

11. Apparatus as claimed in any preceding claim and further comprising light emitting means connected to the radio frequency signal generation means.

12. Apparatus as claimed in any preceding claim and further comprising audio emission means connected to the radio frequency signal generation means.

13. Apparatus as claimed in claim 11 or claim 12 wherein said audio signal generation means and said visual signal generation means have a common interface with the radio frequency signal generation means.

14. Apparatus as claimed in any preceding claim wherein, the housing comprises an inner housing containing the signal generator and the antenna, and an outer housing surrounding the inner housing and containing a power source interface; and wherein said outer housing contains a display screen the housing comprises an inner housing contained.

15. Apparatus as claimed in any of claims 1 to 14, in which the display screen functions as a watch.

16. Apparatus as claimed in claim 15, in which the watch is controlled by a watch circuit contained in a third housing located inside the outer housing.

17. Apparatus as claimed in claim 15 when dependant on claim 4, in which the watch is operated by the control circuit.

18. Apparatus as claimed in any preceding claim, in which the housing is provided with a strap and the housing and strap are dimensioned to be worn on the wrist or ankle of a person.
